(19) United States
(12) Patent Application Publication
(10) Pub. No.: US 2007/0054173 A1
(43) Pub. Date: Mar. 8, 2007

(54) FUEL CELL DEVICE HAVING CIRCUIT COMPONENTS

(76) Inventors: Hsi-Ming Shu, Taipei (TW); Wei-Li Huang, Taipei (TW)

Correspondence Address: G. LINK CO., LTD., 3550 BELL ROAD, MINOOKA, IL, 60447, US

(21) Appl. No.: 11/469,887

(22) Filed: Sep. 4, 2006

(30) Foreign Application Priority Data
Sep. 7, 2005 (TW) 094215370

(51) Int. Cl. H01M 8/02; H01M 8/04

(52) U.S. Cl. 429/38; 429/23

(57) ABSTRACT

A fuel cell device with circuit components is disclosed, which includes at least one fuel cell board, a flow board and at least one circuit component. The fuel cell board is made of at least one laminated and stacked printed circuit substrate, and includes at least one membrane electrode assembly and at least one current collector. The flow board includes a body and a fuel flow channel disposed on the surface thereof. The circuit components are disposed between the flow board and the fuel cell boards.

### FIELD OF THE INVENTION

The present invention relates to a fuel cell device, and more particularly, to a fuel cell device having circuit components that are placed in between the inter-layers of the fuel cell device.

### BACKGROUND OF THE INVENTION

In conventional fuel cell devices, circuits related to the operation of fuel cells, such as energy management circuits, fuel temperature/fuel concentration/fuel level sensing circuits, fuel flow control circuits, etc., are usually externally connected circuits, so these circuits are distantly spaced from the membrane electrode assembly (MEA) layers. Inevitably, the circuits are electrically connected to the MEA layers using cables. As such, it is adverse to the fabrication of miniaturized fuel cell devices.

Because the electronic components of the aforesaid circuits are soldered on the most outer surface of a conventional fuel cell device, some of the electronic components must be protected from accidentally contacting fuels (e.g. methanol) and thus being damaged. On the other hand, conventional fuel cell devices generally employ conductive through holes to electrically connect the electronic components. The through holes may also be harmed due to corrosion from fuels.

In view of the disadvantages of the configuration of electronic components in conventional fuel cell devices, an improved fuel cell device with circuit components is needed, in which the circuit components are embedded in the inter-layers of the fuel cell device.

### SUMMARY OF THE INVENTION

It is a primary object of the invention to provide a fuel cell device having circuit components that are placed in between the inter-layers of the fuel cell device.

It is a secondary object of the invention to provide a fuel cell device with circuit components. Because the circuit components are embedded in the inter-layers of the fuel cell device, the most outer surface of the fuel cell device becomes flat and smooth.

In accordance with the aforementioned objects of the invention, a fuel cell device with circuit components is provided, which includes at least one fuel cell board, a flow board and at least one circuit component. The fuel cell board is made of at least one laminated and stacked printed circuit substrate, and includes at least one membrane electrode assembly and at least one current collector. The flow board includes a body and fuel flow channels disposed on the surface thereof. The circuit components are disposed between the flow board and the fuel cell boards.

### BRIEF DESCRIPTION OF THE DRAWINGS

The present invention will become further fully understood from the detailed description given hereinbelow illustration only, and thus are not limitative of the present invention, and wherein:

FIG. 1 is a perspective and exploded view showing a fuel cell device with circuit components according to an embodiment of the invention;

FIG. 2 illustrates a perspective view of the fuel cell device in FIG. 1;

FIG. 3 is a portion of the cross-section of the circuit components electrically connected together through an electrical interface according to an embodiment of the invention;

FIG. 4 is a portion of the cross-section of the circuit components electrically connected together through an electrical interface according to a modified embodiment of the invention; and

FIG. 5 is a perspective and exploded view showing a fuel cell board according to an embodiment of the invention.

### DETAILED DESCRIPTION OF THE INVENTION

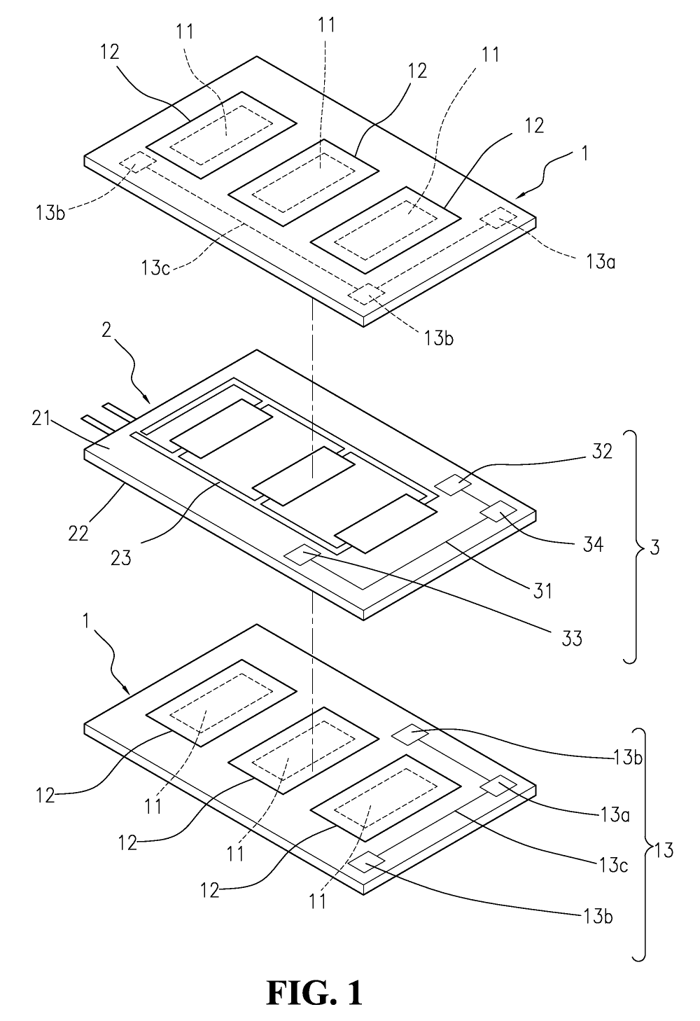

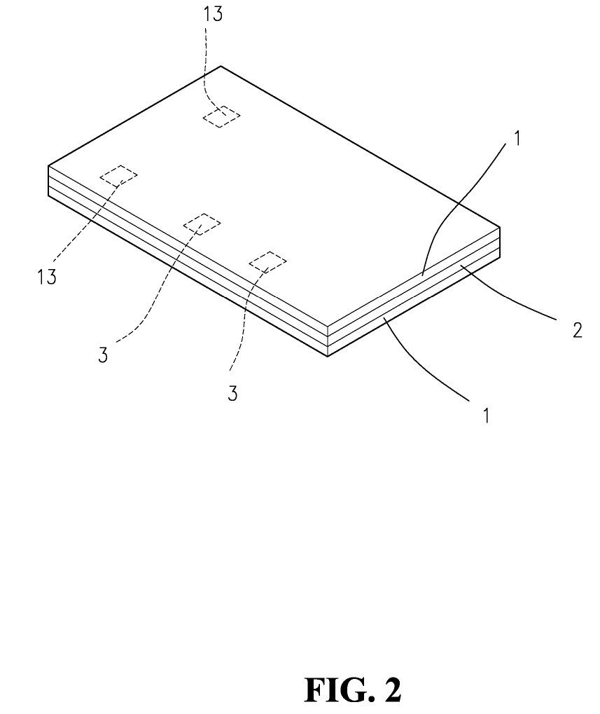

FIG. 1 is a perspective and exploded view showing a fuel cell device with circuit components according to an embodiment of the invention. FIG. 2 illustrates a perspective view of the fuel cell device in FIG. 1. A fuel cell device with circuit components includes at least one fuel cell board 1 combined with a flow board 2, and circuit components 3, 13. The circuit components 3, 13 may be used as circuits for electrical transmission of fuel cells, logic operation and control, which will be separately described hereinafter.

The flow board 2 for a fuel cell device in one embodiment includes a first surface 21 and a second surface 22. The first surface 21 and the second surface 22 are provided for configuring two fuel cell boards 1, respectively. The fuel cell board 1 is a power generator made from multiple laminated layers of printed circuit substrates. For example, the fuel cell board 1 may be a direct methanol fuel cell (DMFC) board, of which the substrate includes multiple layers of FR4 substrates, FR5 substrates, epoxy resin substrates, glass fiber substrates, ceramic substrates, polymeric plastic substrates, or composite substrates, and these layers of substrates are stacked upon one another. The fuel cell board 1 includes at least one membrane electrode assembly (MEA) 11 and at least one current collector 12. The current collector 12 is fabricated by, for example, etching copper foil of a printed circuit substrate to form a meshed current collecting net and coating a thin layer of anticorrosive and conductive material thereon, alternatively, cutting acid-proof and/or anticorrosive metal to form a meshed current collecting net and covering thereon. Each MEA 11 is provided to perform electrochemical reactions and generate current that is output by the corresponding current collecting net 12. The current collecting net 12 is further treated by a protective process like an acid-proofing process or an anticorrosive process, in order to prevent fuels or products produced during electrochemical reactions from damaging the current collecting net 12.

The flow board 2 is a substrate, which may be an FR4 substrate, an FR5 substrate, an epoxy resin substrate, a glass fiber substrate, a ceramic substrate, a polymeric plastic substrate, or a composite substrate. The first surface 21 and the second surface 22 of the flow board 2 each have fuel flow channels 23. The fuel flow channel 23 is a fluid-guiding structure for conducting fluid fuels, such as methanol solution, flowing into the MEAs 11.

The circuit components 3 are disposed on the first surface 21, the second surface 22, or both surfaces 21, 22. An exemplar of the circuit components 3 is a layout wire 31, an electronic component 32, a sensor 33, a first electrical interface 34, and so on. The layout wires 31 are adapted to electrically connect each electronic component to each current collecting net 12.

At least one circuit component 13 is disposed on a surface of the fuel cell board 1 opposite to the MEAs 11. An exemplar of the circuit components 13 is a layout wire 13c, an electronic component 13b and a second electrical interface 13a. Because the first electrical interface 34 and the second electrical interface 13a are coupled to each other, the circuit components 3 of the flow board 2 and the circuit components 13 of the fuel cell board 1 are electrically connected together.

The aforesaid electronic components 32, and 13b are, for example, integrated circuits, constant voltage regulators, constant current regulators, and so forth. An integrated circuit may be a microcontroller capable of logically operating and controlling. The aforesaid sensor 33 may include a device for detecting particular physical properties, such as concentration sensors or temperature sensors, and so on. The first electrical interface 34 is adapted to connect the electronic component 32 and the sensor 33 with other circuit components.

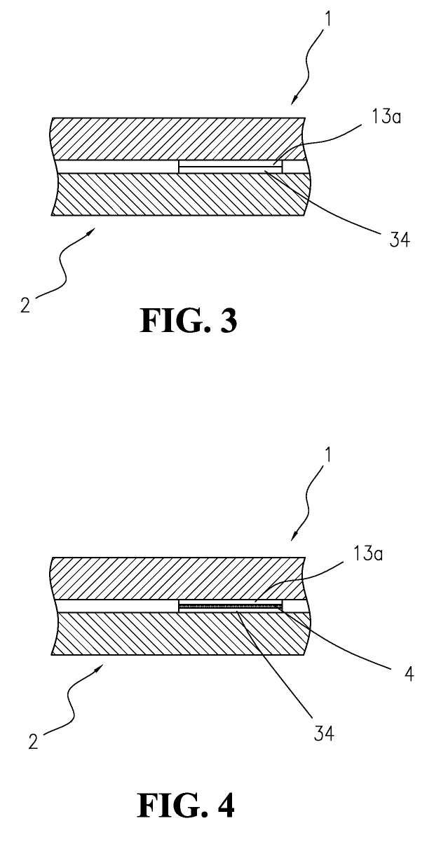

FIG. 3 is a portion of a cross-section of circuit components electrically connected together through an electrical interface according to an embodiment of the invention. The circuit components 3 of the flow board 2 and the circuit components 13 of the fuel cell board 1 are electrically linked together while the electrical interface 34 contacts the electrical interface 13a directly.

FIG. 4 is a portion of a cross-section of circuit components electrically connected together through an electrical interface according to another embodiment of the invention. The circuit components 3 of the flow board 2 and the circuit components 13 of the fuel cell board 1 are electrically linked together through a conductive adhesive medium 4, which adheres the electrical interface 34 to the electrical interface 13a of the fuel cell board 1. A conductive adhesive medium 4 may be fabricated by using silver adhesive, solder welding, or any other means suitable for electrical connection.

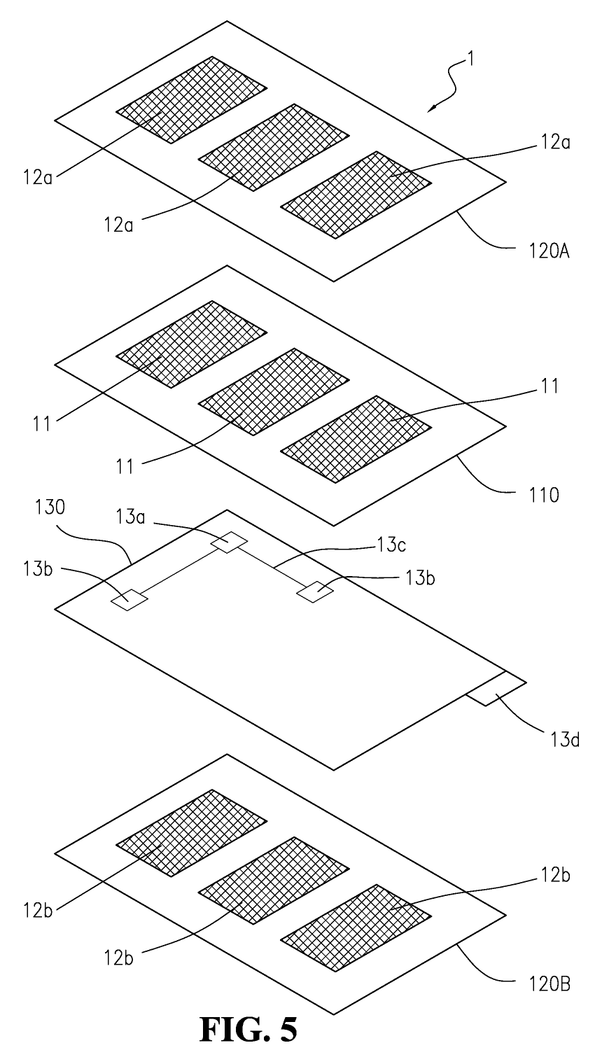

FIG. 5 is a perspective and exploded view showing a fuel cell board according to an embodiment of the invention. From top to bottom, the fuel cell board 1 includes an anode current collection layer 120A, a MEA layer 110 and a cathode current collection layer 120B in sequence. Furthermore, the fuel cell board 1 includes at least one intermediate substrate 130. The intermediate substrate 130 may be sandwiched in between the anode current collection layer 120A and the MEA layer 110, or be placed in between the cathode current collection layer 120B and the MEA layer 110. The anode current collection layer 120A includes at least one anode current collector 12a, and the cathode current collection layer 120B includes at least one cathode current collector 12b. The anode current collectors 12a and the cathode current collectors 12b constitute the aforementioned current collectors 12.

The aforesaid circuit components 13 may be disposed on the surface of the anode current collection layer 120A opposite to the MEA layer 110. Alternatively, the circuit components 13 may be disposed on the surface of the cathode current collection layer 120B opposite to the MEA layer 110. Alternatively, the circuit components 13 may be disposed on the intermediate substrate 130.

One of the circuit components 13 on the intermediate substrate 130 may serve as a third electrical interface 13d. An exemplar of the third electrical interface 13d is a gold finger or a connector.

If the aforesaid anode current collection layer 120A or the cathode current collection layer 120B is made of multiple stacked layers of substrates, the circuit components 13 can be sandwiched within these multiple layers of a current collection layer.

If the aforesaid flow board 2 is made of multiple stacked layers of substrates, the circuit components 3 can be sandwiched within these multiple layers of a flow board.

To avoid qualitative changes to circuit components and adhesive media, a protective treatment for acid-proofing or anti-corrosion may be further applied onto the surfaces of circuit components and adhesive media after adhesion; for example, by covering the surfaces with AB glue.

One feature of the invention consists in the configuration of circuit components, which are placed in between the inter-layers of a fuel cell device. Therefore, the most outer surface of a fuel cell device is flat and smooth.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device having circuit components, comprising:
at least one fuel cell board made of at least one laminated and stacked printed circuit substrate, and including at least one membrane electrode assembly and at least one current collector;
a flow board including a body and a fuel flow channel disposed on a surface of the body; and
at least one circuit component disposed between the flow board and the fuel cell board.

2. The fuel cell device having circuit components of claim 1, wherein the fuel cell board comprises an FR4 substrate, an FR5 substrate, an epoxy resin substrate, a glass fiber substrate, a ceramic substrate, a polymeric plastic substrate, or a composite substrate.

3. The fuel cell device having circuit components of claim 1, wherein the flow board comprises an FR4 substrate, an FR5 substrate, an epoxy resin substrate, a glass fiber substrate, a ceramic substrate, a polymeric plastic substrate, or a composite substrate.

4. The fuel cell device having circuit components of claim 1, wherein the circuit component is disposed on a first surface and/or a second surface of the flow board.

5. The fuel cell device having circuit components of claim 1, wherein the circuit components are disposed on a surface of the fuel cell board, and the surface overlaps the flow board.

6. The fuel cell device having circuit components of claim 1, wherein the circuit components comprise a layout wire, an electronic component, an integrated circuit, a constant voltage regulator, a constant current regulator, or a sensor.

7. The fuel cell device having circuit components of claim 1, wherein the circuit components comprise at least one first electrical interface and at least one second electrical interface.

8. The fuel cell device having circuit components of claim 7, wherein the first electrical interface is disposed on a first surface and/or a second surface of the flow board, and the second electrical interface is disposed on a surface of the fuel cell board, and the surface of the fuel cell board overlaps the flow board.

9. The fuel cell device having circuit components of claim 8, wherein the first electrical interface directly contacts the second electrical interface.

10. The fuel cell device having circuit components of claim 8, further comprising a conductive adhesive medium to adhere the first electrical interface to the second electrical interface, so as to electrically connect the first electrical interface with the second electrical interface.

11. The fuel cell device having circuit components of claim 1, wherein the fuel cell board comprises from top to bottom:
an anode current collection layer including at least one anode current collector;
a membrane electrode assembly layer including the membrane electrode assembly; and
a cathode current collection layer including at least one cathode current collector;
wherein the anode current collector and the cathode current collector constitute the current collector.

12. The fuel cell device having circuit components of claim 11, wherein the circuit components are disposed on a surface of the anode current collection layer opposite to the membrane electrode assembly layer, and/or is disposed on a surface of the cathode current collection layer opposite to the membrane electrode assembly layer.

13. The fuel cell device having circuit components of claim 11, wherein the fuel cell board further comprises at least one intermediate substrate sandwiched in between the anode current collection layer and the membrane electrode assembly layer and/or between the cathode current collection layer and the membrane electrode assembly layer, wherein the circuit component is disposed on the intermediate substrate.

14. The fuel cell device having circuit components of claim 13, wherein the circuit components comprise a third electrical interface.

15. The fuel cell device having circuit components of claim 14, wherein the third electrical interface is a gold finger or a connector.

16. The fuel cell device having circuit components of claim 1, wherein the flow board comprises multiple stacked layers of substrates, and the circuit component is embedded in the flow board.
